(19) United States
(12) Patent Application Publication
(10) Pub. No.: US 2004/0069860 A1
(43) Pub. Date: Apr. 15, 2004

(54) Pool fountain

(76) Inventor: Ellis B. Nary, Nokomis, FL (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/664,766

(22) Filed: Sep. 17, 2003

Related U.S. Application Data
(60) Provisional application No. 60/411,975, filed on Sep. 18, 2002.

(51) Int. Cl. B05B 17/08

(52) U.S. Cl. 239/17

(57) ABSTRACT

A swimming pool fountain including a bracket that is easily connected to the water supply of the swimming pool and is secured in a stable position relative to the wall of the pool has been provided. Means are provided for changing the vertical elevation of the fountainhead to the desired level relative to the water level of the pool. Also, the arrangement is such that it minimizes the problem of injury to swimmers and pool circulation plumbing by providing for separation upon a load being imposed on the structure. The same connection facilitates removal of the fountain structure from the pool if it should be desired and use can easily be made to the fountainhead to change the artistic aspects of the fountain.

### REFERENCE TO RELATED APPLICATION

This application claims priority from U.S. Provisional Patent Application Serial No. 60/411,975 filed Sep. 18, 2002, the content of which is incorporated herein by reference.

### FIELD OF THE INVENTION

This invention relates to water fountains and more particularly to fountains used with swimming pools that may obtain their source of water for the fountain from the pool filter system or the water input connection.

### BACKGROUND OF THE INVENTION

Fountains for use with swimming pools have been provided in an effort to afford the decorative effect and the relaxing sound, especially when the pool is not in conventional use to provide an esthetically pleasing background or view.

Such fountains are typically supplied with water under pressure, which is discharged through a fountain head having multiple orifices. The pressurized water is supplied by the water fill system of the pool or the outlet of a re-circulating filter system. Such fountains can cause problems because of the obstruction of the installation to the normal use of the pool. In addition, variations in pool configurations make installation a custom job. Also, removal of such fountains temporarily for active use of the pool have been difficult. Such pools also typically have a figurine as part of the fountain or spray head, which not only must be supported relative to the pool but also usually is fixed so that change is a major installation problem.

### SUMMARY OF THE INVENTION

It is an object of the invention to provide a fountain for swimming pools, which is easily installed and also easily disconnected and removed if desired.

Another object of the invention is to provide a swimming pool fountain, which can accommodate different water levels.

A further object is to provide a swimming pool fountain incorporating decorative figurines to complement the discharge of water from the fountain and one in which the figurines can easily be removed and changed. Yet another object of the invention is to provide a fountain for swimming pools in which the water pressure can be varied from the maximum to some intermediate desired pressure easily and without requiring special tools.

These and other objects of the invention are attained by a swim-ring pool fountain which includes a bracket that is easily connected to the water supply and is secured in a stable position relative to the wall of the swimming pool and provides means for changing the vertical elevation of the fountain head to a desired level relative to the water level of the pool with which the fountain is used. The arrangement is such that it minimizes the problems of injury to swimmers and pool circulation plumbing by providing for separation upon a load being imposed on the structure. The same connection facilitates removal of the fountain structure from the pool if that should be desired. Also changes in the fountain head are facilitated by an easily operated adaptor.

### BRIEF DESCRIPTION OF THE DRAWINGS

FIG. 1 is a side elevation of the swimming pool fountain embodying the invention shown in a partially installed condition relative to the wall of a swimming pool;

FIG. 2 is a perspective view at a reduced scale showing the entire fountain assembly separated from the pool connections;

FIG. 3 is an elevational view at an enlarged scale of one of the several couplings making up the structure supporting the fountain relative to the pool;

FIG. 4 is an exploded view of a breakaway connection between the fountain supporting bracket and the pool;

FIG. 5 is a view of still another portion of the bracket supporting the fountain; and

FIG. 6 is a side elevation of another embodiment of the invention with one portion exploded for better disclosure.

DETAILED DESCRIPTION

The swimming pool fountain embodying the invention is designated generally at 10 and includes a fountain head assembly 12 and supporting bracket assembly 14. The supporting bracket assembly 14 not only supports the fountain head assembly 12 above the water level 15 and relative to the swimming pool wall 16 but also serves to deliver pressurized water required to activate the fountain assembly 12.

Bracket assembly 14 is made up of tubular components comprises a generally U-shaped configuration with one of the legs forming an upper horizontal portion 18 and the lower leg forming a lower horizontal portion 20 which are joined together by a bight portion 22 forming a vertical component in the installed position. The vertical portion 22 has an extension 24 projecting vertically above the upper leg 18 so that the leg 18 and portion 22 form a vertical water conduit.

The upper or horizontal leg 18 is provided with a slip fitting by which a smaller tube portion 26 telescopes within the larger tube portion 28 and can be held in a selected axial position by a nut 30 threaded on the end of the larger tube portion 28. The small tube 26, large tube 28 and tube 30 are considered to make up a slip coupling designated generally at 32 as shown in FIG. 3.

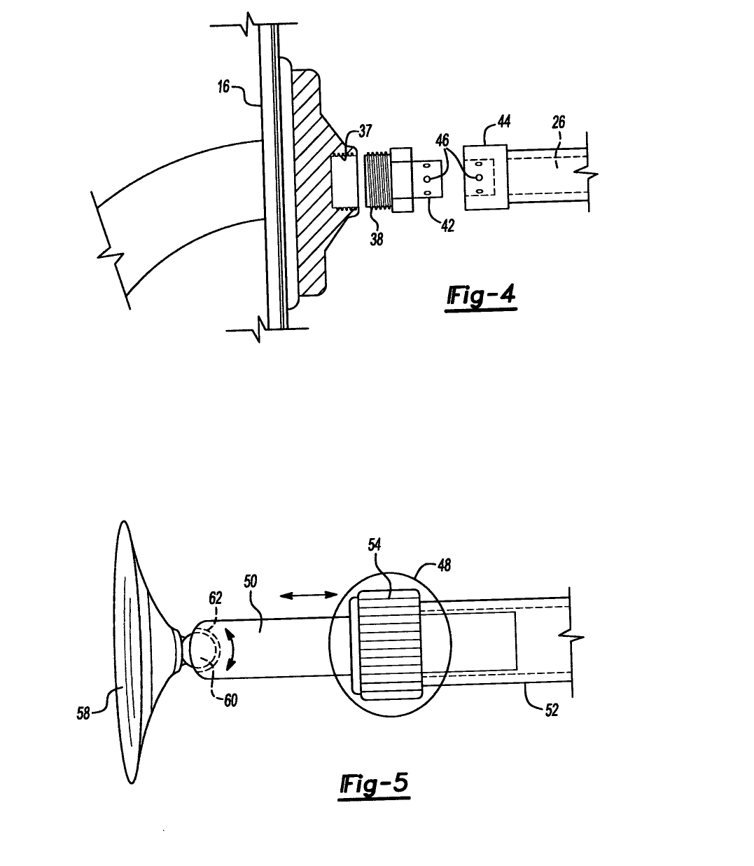

The free end of the small tube 26 opposite the slip coupling 32 is provided with breakaway coupling 36 that serves to connect a source of pressurized water designated at 37, which can be the outlet of either a water supply line or a return line from the pool filtering system. The breakaway coupling 36 includes a threaded adaptor 38 as best seen in FIG. 4 which threads into the orifice of the pool water outlet 37. The opposite end of the threaded adaptor 38 forms a male coupling connector 42 which is adapted to be received by a female coupling connector 44. The female portion 44 of the breakaway coupling 36 is threaded or otherwise fixed to the end of small tube 26. Mating detents 46 are provided on the coupling portions 42 and 44 to permit easy separation upon a load being put on the bracket assembly 14.

The lower leg 20 of the bracket assembly 14 is provided with a slip coupling 49 generally similar to the slip coupling 32 and serves to join telescoping small tube 50 and a large tube 52 and to hold the two tubes in position by tightening of the nut 54.

The free end of the small tube 50 of the lower, horizontal leg 20 is provided with a suction cup 58, which is shown in FIG. 5 is held in position by a ball joint formed by a ball 60 attached to the suction cup 58 fitted in a socket 62 formed in the free end of the small tube 50. The ball and socket 60, 62 permit limited angular positions relative to the lower leg 20 to accommodate variations in pool walls.

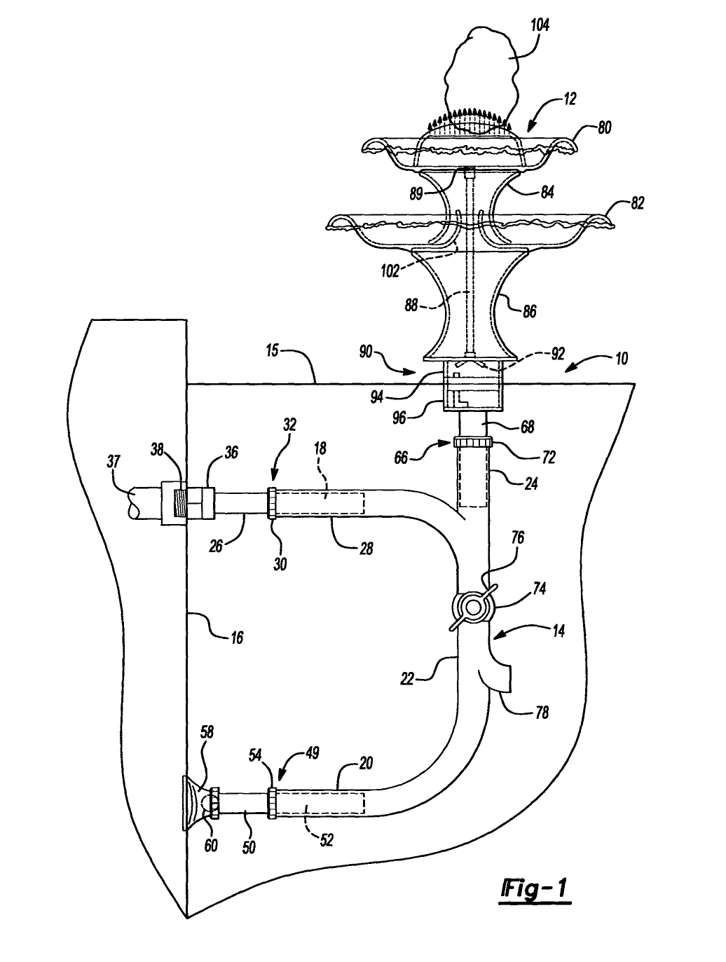

A third slip coupling 66 similar to the slip couplings 32 shown in FIG. 3 is formed in the vertical tube extension 24 seen in FIG. 1 to join a small tube 68 telescoped within the larger tube formed by the bracket extension 24. Upon tightening of the nut 72, the tubes 68 and 24 are secured in fixed relationship to each other and serve as the vertical adjustment of the fountainhead 12 relative to the level of water in the pool.

The bracket assembly 14 also includes a water control valve 74. The valve 74 is of conventional design and is preferably a full port ball type which is controlled by a handle 76, the position of which determines the amount of water which can flow from the water outlet 37 to the by pass outlet 78 and to the tubular bracket extension 24 and therefore to the fountain head assembly 12.

The fountain head assembly 12 illustrated in the FIG. 1 includes an upper tier or bowl 80 and a larger lower tier or bowl 82 held in spaced relationship to each other by axially disposed, generally tubular pedestals 84 and 86. The tiers or bowls 80 and 82 and pedestals 84 and 86 are held together by an axially disposed water delivery tube 88. The upper end of tube 88 is threadably engaged in the bottom of bowl 80 as designated at 89 in FIG. 1 and the lower end is detachably connected to a twist lock coupling 90 by way of a bushed out male adapter with seal and wing nut 92 threaded on the lower end of tube 88. The sealed adapter prevents water from filling bottom pedestal 86. The wing nut 92 is easily accessible when coupling 90 is separated into two parts.

Coupling 90 is of the twist lock type and includes an upper female component 94 and a lower male component 96 which telescope into each other are twisted to prevent axial separation.

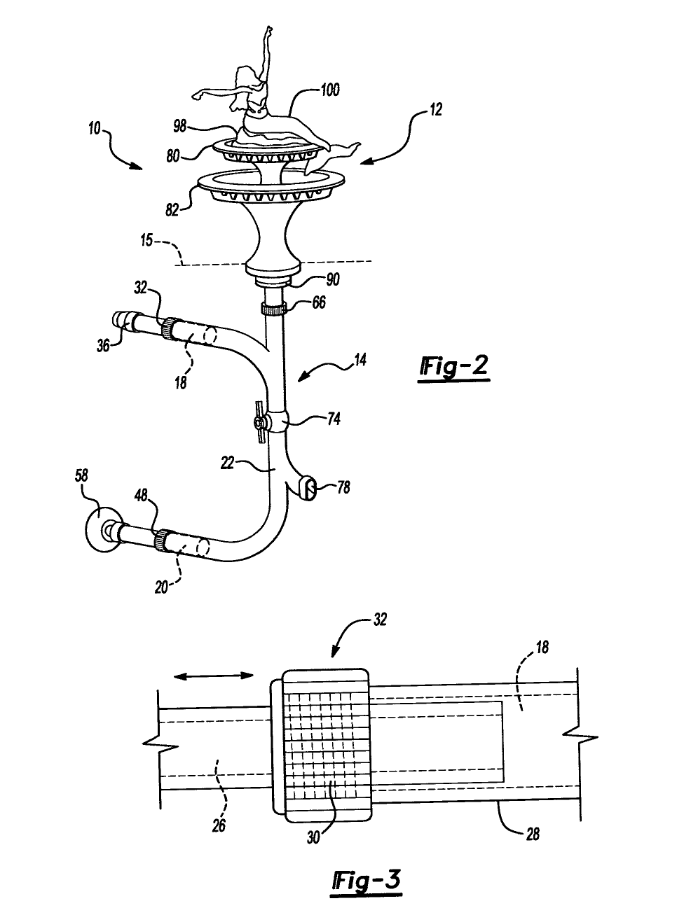

The upper tier 80 of the fountain 12 can be provided with a spray dome 98 having multiple orifices for ejecting water. A figurine, such as the mermaid 100 seen in FIG. 2, can be supported on the dome 98. Figurines of various themes such as dolphins, classic statuary, dancer, etc. can be substituted if desired to change the display located in the position designated at 104 in FIG. 1. Also various ornamentation can be attached to the bowls 80 and 82 of the fountain head assembly 12 to achieve a desired effect.

Water delivered from the tube 88 is delivered to the spray dome 98 and as water fills the upper bowl 80 it cascades over the rim to the lower bowl 82 and from there it cascades over the rim to return to the pool. The lower bowl 82 is provided with a central tubular portion 102 which extends above the rim of the bowl 86 so that water is prevented from flooding the pedestal 86 and increasing the weight of the fountain head assembly 12 that must be supported by the bracket assembly 14.

Although the fountain head assembly 12 has been described in terms of upper and lower tiers or bowls 80 and 82, it should be understood that a single tier or more than two tiers could be used in an assembly to provide a fountain head.

Installation of fountain 10 in a swimming pool begins with the bracket assembly 14 separated from the fountain head assembly 12 and including only the male portion 96 of the twist lock coupling 90. After insertion of threaded adaptor 38 into the water outlet fitting 37, the separated breakaway coupling 36 may be brought together and the bracket assembly 14 adjusted to place the suction cup 58 in a temporary position immediately and vertically below the coupling 36. Thereafter the slip coupling 66 can be manipulated to insure that the male portion 96 of the slip coupling 90 is at or slightly below water level and the nut 72 can be tightened to maintain this position. Similarly, the nuts 30 and 54 can be manipulated to insure that the portion of the bracket assembly 14 including the bight portion 22 and tube 70 are in a vertical position. Thereafter applying downward force on the top of the bracket 14 at coupling 96 will transmit force through the brace member afforded by the vertical portion 22 in a horizontal position 20. The suction cup 58 into position against the wall 16 of the swimming pool. In this condition the bracket is stable and firmly attached to the wall 16 of the swimming pool by way of the suction cup 58 and the breakaway coupling 36.

The fountain head assembly 12 can be partially assembled by fastening the water delivery tube 88 to hold the lower pedestal of the fountain to the female portion 94 of the slip lock connector 90 by tightening the wing nut 92 on the end of the water delivery tube 88. In the case of a single tier fountain, the delivery tube would be corresponding shorter since this would be the only tier.

The sub-assembly formed by the tube 88, coupling portion 94 and lower pedestal 86 can then be placed successively in position on the bracket assembly 14 by aligning the two coupling portions 94 and 96 of the twist lock coupling 90. This should locate the water delivery tube 88 in a vertical position with the bottom of the pedestal 86 at or near the water level of the pool. Thereafter the remainder of the fountain head assembly 12 can be placed in position by successively adding the lower tier 82, the pedestal 84 and the tier 80 including the figurine 100 or 104. The top tier 80 is added to complete the fountain head assembly 12 and done by threading it on the top end of the water delivery tube 88. As the tier becomes tightened on the pipe it can be rotated to any selected position to achieve the desired location.

If preferred, the entire fountain head assembly 12 can be pre-assembled relative to the upper or female portion 94 of the twist lock coupling 90 and the entire assembly can be placed in position on the bracket assembly 14 to bring the coupling portions 94 and 96 of the twist lock coupling 90 into alignment and locked condition relative to each other. Some models of the fountainhead portions 12 may be made of heavy material and consequently the full assembly may be more difficult to manipulate.

With the fountain 10 installed relative to the pool wall 16, water delivery to the fountain head 12 can be controlled by means of the valve 74 with the control handle 76 being reachable below the water level from the edge of the pool with either the hand or the foot. By controlling the position of the handle 26, the amount of water delivered to the fountain 12 and to the bypass to return to the pool 78 can be regulated. Such regulation also controls the height of the water ejected above the fountain head dome 98.

This disassembly of the fountain 10 is the reverse of the installation procedure but more particularly can be achieved by using the twist lock coupling 90 to disengage the fountain 12 from the remainder of the bracket assembly 14. The bracket assembly itself can be removed by separating the breakaway coupling 36 and manipulating the remainder of the bracket assembly 14 to disengage the suction cup 58 from the wall of the pool 16.

The arrangement is such that if lateral loads are accidentally imposed on the fountain 10 and particularly lateral loads, the breakaway coupling 36 can separate from the pool wall, thereby protecting not only the users of the pool but also the underground pool plumbing.

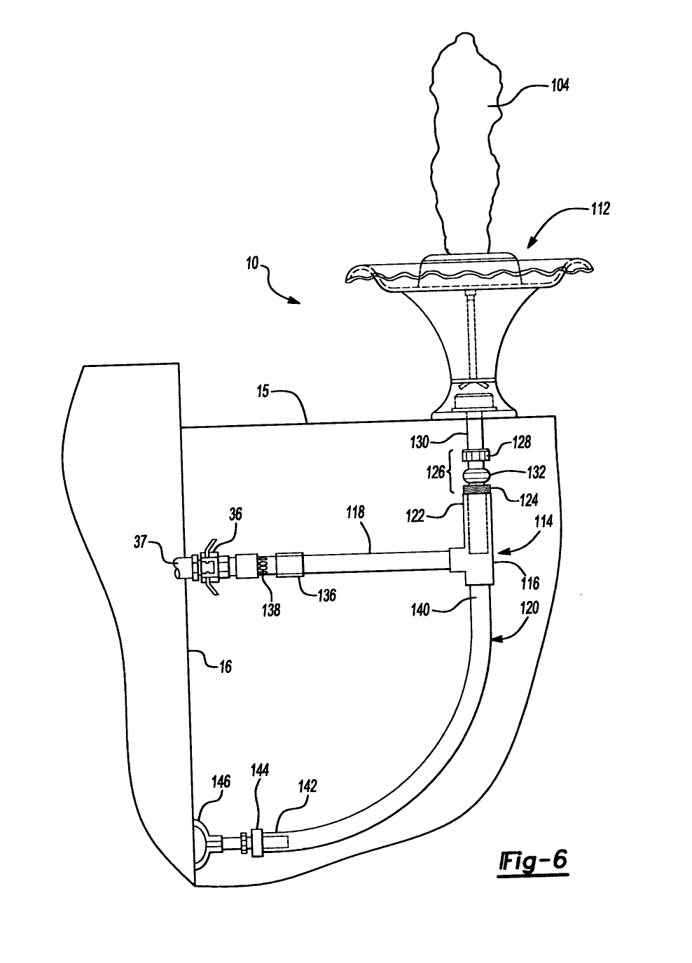

Another embodiment of the pool fountain shown in FIG. 6 and is designated generally at 110. The fountain 110 includes a fountainhead assembly 112 which can be the same as that of the prior embodiment or can be of a single tier 82 as illustrated in FIG. 6.

The fountainhead 112 is supported in position relative to the wall of the pool by a bracket assembly 114 which includes a vertical water conveying fitting 116 to mount a horizontally extending tubular conduit for conveying water connected at a lower portion of the vertical fitting and a brace member 120 which is curved through a ninety degree arc with its upper vertical portion 122 connected to the vertical fitting 116.

The upper end of vertical fitting 116 is formed with threads 124 shown in the exploded view of the slip fitting 126 in FIG. 6. The slip fitting 126 also includes a tube 50 which telescopes within the upper end of the vertical fitting 116. Slip fitting 126 also includes a seal 52 which is compressed when the nut 118 and threads 124 are joined to form a water seal and hold the tube 150 at its vertical position relative to the bracket assembly 114 for adjustment of the fountainhead 112 relative to the water level in the pool. The upper end of the tube 140 is fixed to a twist lock coupling identical to the coupling 90 seen in the prior embodiment for securing the fountain to the bracket assembly 114.

The horizontal conduit 118 is fixed in water communication with the vertical fitting 116 at one end and its opposite end be connected to water supply 37 by way of a breakaway coupling 36 in the form of an easily disconnected coupling.

An adjustable water valve is provided by a sleeve 156 slidably mounted on the exterior of the horizontal conduit 118 in proximity to a plurality of apertures ranged circumferentially around the surface of the pipe. By way of example, if a horizontal conduit 118 of one and one-half inch diameter PVC pipe eight holes having a diameter of one-half inch are arranged annularly about the circumference of the tube 118. Sliding of the sleeve 156 over a portion or the entire area of the openings serves to regulate the flow of water which is diverted from the fountainhead 112 and spilled to the pool. It also serves to regulate the height of the spray ejected from the fountain.

The brace member 120 has an upper vertical portion 140 which fits into and is fixed to the vertical fitting 116. Brace member 120 is bent through a ninety-degree arc from the vertical portion 140 to a lower horizontal portion 142. The lower horizontal portion 142 is provided with a slip fitting 144. The slip 144 connects a suction cup 46 on a solid rod member 148 which is received within the horizontal portion 142.

As with the first embodiment of the invention, the bracket assembly 114 in the embodiment in FIG. 6 can be made of readily available PVC tubular pipe and fittings.

In the second embodiment of the invention in FIG. 6 the vertical position of the vertical fitting 116 can be adjusted relative to the swimming pool wall by means of the slip fitting 144 by telescoping the rod 148 in the lower horizontal portion of the brace member 120.

The openings 138 also serve as a line of weakening which will fracture under loads being imposed transversely of a vertical plane in which the components 116, 118 and 120 of bracket 114 are disposed. Fracturing along the line of weakening serve to detach the entire fountain from the wall 16 of the pool.

A water fountain for swimming pools has been provided in which installation is easily achieved in a variety of pool configurations and sufficient adjustment is provided to not only correctly position the fountain but also to enable portions to be selectively positioned for esthetic purposes. The fountain is such that once installed water height flow of the fountain can be easily regulated. Also the fountainhead configuration can be easily changed to a variety of themes or figurines.

1. A fountain for a pool having a generally vertical wall and a below water surface water outlet comprising:
a support structure including a vertical water conduit having an upper end extending above the water surface;
a horizontal water conduit having one end in water communication with said vertical conduit and the other end having means for connecting to the water outlet;
a brace member having one end connected to said vertical conduit and having the other end engageable with a wall of said pool in spaced relation to said other end of said vertical conduit, said vertical conduit, said horizontal conduit and said brace member being disposed in a common vertical plane; and
a fountainhead for spraying water detachably connected in water communication with said upper end of said vertical conduit.

2. The fountain of claim 1 wherein said one end of said brace member has a horizontally extending portion adjustable in length to position said vertical conduit vertically.

3. The fountain of claim 2 wherein said horizontally extending portion of said brace member is a telescoping connection.

4. The fountain of claim 1 wherein said other end of said brace member has a suction cup for engaging the wall of the pool.

5. The fountain of claim 1 and further comprising valve means in said support structure to divert water from said fountain to the pool.

6. The fountain of claim 5 wherein said valve means is positioned in said horizontal water conduit.

7. The fountain of claim 5 wherein said valve means is formed by a plurality of openings in said conduit and a sleeve is selectively slideable on the exterior of said conduit to cover all or some of said openings.

8. The fountain of claim 7 wherein said openings are arranged circumferentially on said conduit.

9. The fountain of claim 8 wherein said openings form a line of weakening which can fracture upon unusual loads imposed transversely to said vertical plane.

10. The fountain of claim 1 wherein said horizontal member has means for adjusting its length to position said vertical conduit vertically.

11. The fountain of claim 2 wherein said means for adjusting is a telescoping connection.

12. A pool fountain, comprising:
a fountainhead for discharging water into the air above the surface of the water in the pool;
a vertical water conduit having an upper end detachably connected to and supporting said fountainhead;
a horizontal water conduit having a first end connected in water communication to a lower end of said vertical conduit and a second end detachably connected in water communication with a water supply outlet in the wall of said pool; and
a brace member having one end in abutting relation with the wall of said pool vertically below said water supply and the other end fixed to the lower end of said vertical conduit to support the latter and said fountain in horizontally spaced relation to the wall of the pool.

13. The pool fountain of claim 12 wherein said brace member has a suction cup formed at said one end of said brace member.

14. The pool fountain of claim 12 wherein said vertical water conduit is adjustable in length vertically to position said fountainhead relative to the surface of the water.

15. The fountain of claim 12 wherein said one end of said brace member has a horizontally extending portion adjustable in length to position said vertical conduit vertically.

16. The fountain of claim 12 wherein said horizontally extending portion of said brace member is a telescoping connection.

17. The fountain of claim 12 and further comprising valve means in said support structure to divert water from said fountain to the pool.

18. The fountain of claim 17 wherein said valve means is positioned in said horizontal water conduit.

19. The fountain of claim 17 wherein said valve means is formed by a plurality of openings in said conduit and a sleeve is selectively slideable on the exterior of said conduit to cover all or some of said openings.

20. The pool fountain of claim 19 wherein said openings are arranged circumferentially to form a line of weakening which can fracture upon unusual loads imposed on said water conduits and said brace member.
